(19) United States
(12) Patent Application Publication
(10) Pub. No.: US 2004/0222879 A1
(43) Pub. Date: Nov. 11, 2004

(54) Pillow vibration ringer and related methods

(76) Inventors: Charlie Sawyer, Orlando, FL (US); Isaac D. White, Orlando, FL (US); James E. Dickens, Ocoee, FL (US); Blake Urban, Lenoir, NC (US); Kevin Forsberg, Orlando, FL (US)

Correspondence Address: MYERS BIGEL SIBLEY & SAJOVEC, P.A., P.O. BOX 37428, RALEIGH, NC, 27627, US

(21) Appl. No.: 10/431,299

(22) Filed: May 7, 2003

(51) Int. Cl. H04B 3/36

(52) U.S. Cl. 340/407.1

(57) ABSTRACT

A vibration ringer for vibrating a pillow responsive to a signal includes a vibration generator adapted for placement adjacent the pillow and adapted to vibrate the pillow providing a reduced sound vibration ring, and an actuator adapted to actuate the vibration generator responsive to the signal.

### BACKGROUND OF THE INVENTION

The present invention relates to alarm notification devices, and, more particularly, to vibration ringers.

Mobile telecommunications devices such as mobile phones and pagers typically alert the user to an incoming call or page with an audible ring. Audible rings can be disruptive to other people, particularly in a group setting such as in auditoriums or lecture halls. Vibration rings have been developed to alert the user to an incoming call using vibrating motion. Telecommunications devices with vibration rings typically are configured to toggle between an audible ring mode and a vibration ring mode. While in vibration ring mode, the user can wear the communications device, for example, on a belt or in a pocket, so that the vibrations can be felt.

However, in some situations, it may not be feasible to wear a vibration ring communications device due to comfort and freedom of motion considerations, for example, when a user is sleeping. While sleeping, users typically leave telecommunications devices in an audible ring mode. The audible ring may be disruptive to others who share a sleeping space with the user.

Alarm clocks typically have audible rings that can be disruptive to others, for example, if a user shares a sleeping space with another person who may not wish to wake Lip at the same time as the alarm. Audible ringers may be disruptive in other situations as well. For example, hotels may have “wake-up call” services that provide an audible alarm, typically a telephone ring, at a time chosen by the hotel guest. However, if guests are sharing rooms and do not wish to wake up at the same time, an audible alarm can disrupt the sleep of the guest who wishes to sleep longer.

### SUMMARY OF THE INVENTION

According to embodiments of the present invention, a vibration ringer for vibrating a pillow responsive to a signal includes a vibration generator adapted for placement adjacent the pillow and adapted to vibrate the pillow providing a reduced sound vibration ring, and an actuator adapted to actuate the vibration generator responsive to the signal.

In further embodiments of the invention, a vibration ringer system for vibrating a pillow responsive to a signal includes a pillow and a vibration generator placed adjacent the pillow and adapted to vibrate the pillow providing a reduced sound vibration ring. An actuator is adapted to actuate the vibration generator responsive to the signal.

According to further embodiments of the invention, a vibration ringer system for vibrating a pillow includes a transmitter adapted to generate a signal. A vibration ringer is spatially removed from the transmitter. The vibration ringer includes a vibration generator adapted for placement adjacent the pillow and adapted to vibrate the pillow providing a reduced sound vibration ring, and an actuator adapted to actuate the vibration generator responsive to the signal from the transmitter.

According to still further embodiments of the present invention, a method for providing a reduced sound vibration ring includes providing a plurality of vibration ringers adapted to vibrate a pillow member responsive to a signal. An actuation time associated with one of the plurality of vibration ringers is accepted. One of the plurality of vibration ringers is vibrated at the actuation time.

### BRIEF DESCRIPTION OF THE DRAWINGS

FIG. 1 is a schematic view of a pillow vibration ringer system according to some embodiments of the present invention;

FIG. 2 is an enlarged cross-sectional view of the pillow vibration ringer of FIG. 1;

FIG. 3 is a flow chart illustrating operations that may be executed by the pillow vibration ringer of FIG. 1;

FIG. 4 is a flow chart illustrating further operations that may be executed by the pillow vibration ringer of FIG. 1;

FIG. 5 is a flow chart illustrating further operations that may be executed by the pillow vibration ringer of FIG. 1; and

FIG. 6 is a flow chart illustrating further operations that may be executed by the pillow vibration ringer of FIG. 1.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art. It will be understood that when an clement is referred to as being “connected to” or “coupled to” another element, it can be directly connected or coupled to the other element or intervening elements may also be present. In contrast, when an element is referred to as being “directly connected” or “directly coupled” to another element, there are no intervening elements present.

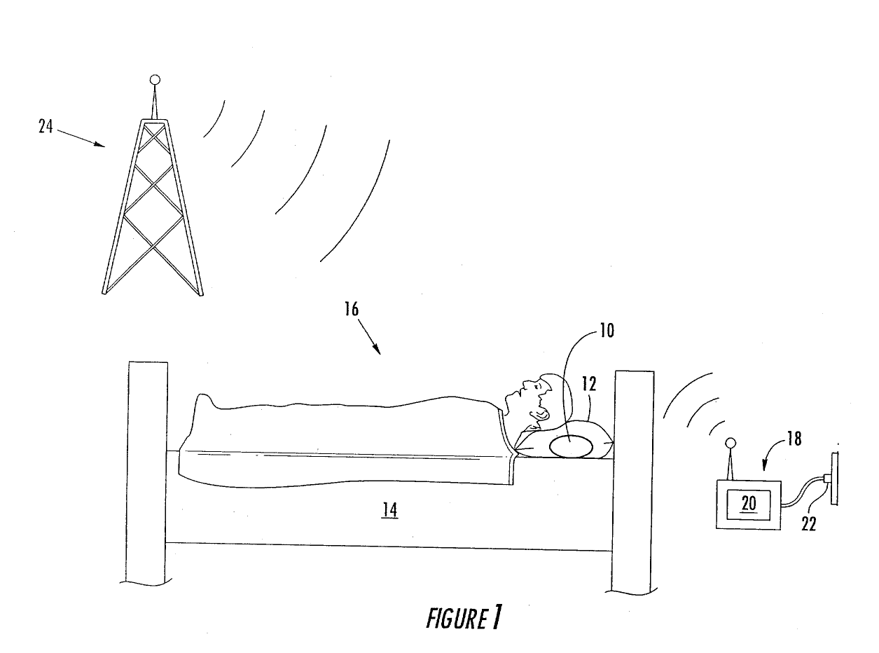

FIG. 1 illustrates a vibration ringer 10 according to embodiments of the present invention installed in a pillow 12. The pillow 12 provides head support to a user 16 in a sleeping position on a bed 14. The vibration ringer 10 is adapted to vibrate the pillow 12 responsive to a signal. The vibration of the pillow 12 can be an oscillating displacement at a frequency and amplitude sufficient to impart a physical sensation to the user 16. The signal can be a paging signal, a wireless telecommunications signal, or any suitable signal.

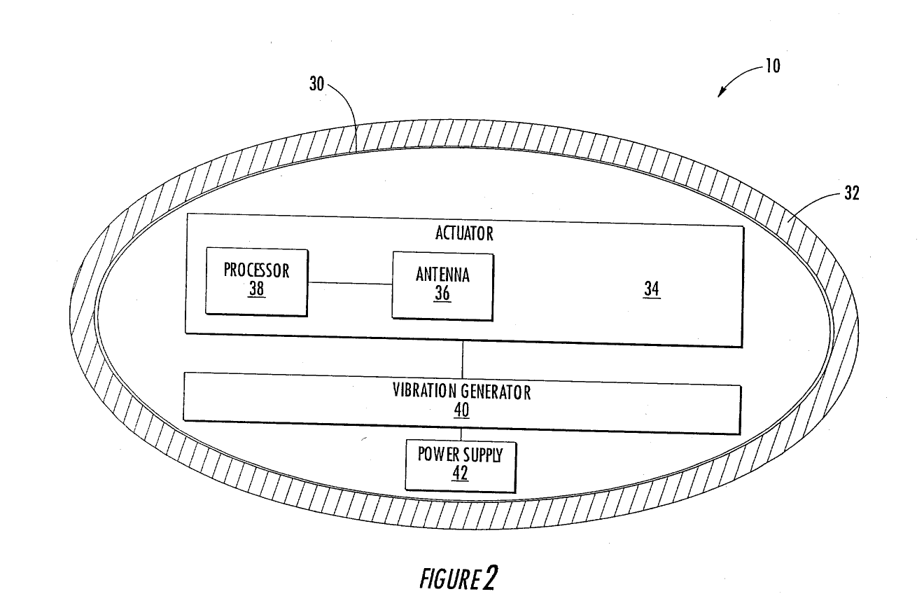

The signal is transmitted to the vibration ringer 10, e.g., from a transmitter 18 and/or a wireless communications system 24. The vibration ringer 10 actuates a vibration generator (e.g., as illustrated in FIG. 2) that vibrates the pillow 12. The user 16 feels the vibration of the pillow 12. In this manner, the user 16 is alerted to an incoming page and/or awakened from sleep, and noise and/or disruption to other people can be reduced.

The vibration ringer 10 is placed so that the vibration ringer 10 causes minimal discomfort to the user 16 during sleep. As illustrated, the vibration ringer 10 is a flat disk configured so that the major surface area of the vibration ringer 10 extends horizontally across the length and width of the pillow 12 to increase the area of vibration. The vibration ringer 10 is also relatively thin in the vertical direction so that the vibration ringer 10 adds a relatively small amount of material to the thickness of the pillow 12.

The pillow 12 may include a pillowcase that is filled with a compressible cushioning material such as down, feathers, or foam rubber, and is configured to cushion the head of a person, especially during sleep or rest. The pillowcase is typically made of cloth and is sized to provide support to a human head when filled with the cushioning material. For example, the pillow 12 can be between about two to three feet long and about one to two feet wide. The uncompressed thickness of the pillow 12 can range between a few inches to about a foot, and the compressed thickness is typically a few inches.

The vibration ringer 10 is placed adjacent the pillow 12 to vibrate the pillow 12. As shown, the vibration ringer 10 is embedded in the pillow 12. Alternatively, the vibration ringer 10 can be situated proximate the pillow 12, for example, on the side of the pillow 12 adjacent the bed 14, or installed in the pillowcase of the pillow 12. In some embodiments, the vibration ringer 10 is removably installed in the pillow 12. For example, the vibration ringer 10 can be placed in a pocket or other enclosure in the pillow 12 or the pillowcase so that the vibration ringer 10 is accessible and can be removed by the user.

The signal may be transmitted to the vibration ringer 10 by various techniques. For example, the wireless communications system 24 may transmit the signal to the vibration ringer 10 to actuate vibration. The wireless communications system 24 can be any suitable system including an analog system, a digital system, a data communications system, a wireless Internet communication system, wireless Ethernet, a cellular radio communications system and/or a satellite communications system. The wireless communications system can include wired or wireless components. For example, cellular radio communications systems typically include regions or cells, each of which is defined by a corresponding radio base station. Each radio base station of a cellular radio communications system can be connected to a Mobile Telephone Switching Center (MSC) for providing control and other cellular radio communications system functions. An MSC typically includes a cellular processor and a cellular switch connected to provide an interface to other associated communications networks, such as a Public Switched Telephone Network (PSTN).

Alternatively, the transmitter 18 may transmit the signal to the vibration ringer 10. The transmitter 18 is spatially remote from the vibration ringer 10. The transmitter 18 includes an optional display 20 for displaying information about received signals. For example, if the signal from the telecommunications system is a paging signal, the display 20 displays the number of the user making the page. The display 20 may also display other information such as a date and/or time of day.

As illustrated, the transmitter 18 is connected to a telecommunications system, such as a PSTN, by a telephone jack connector 22. The transmitter 18 could also be configured to receive signals from a wireless communications system, and the telephone jack connector 22 may be omitted. In such configurations, the transmitter 18 receives signals from a telecommunications system and transmits a signal to the vibration ringer 10. Alternatively, the transmitter 18 can be a stand-alone programmable device that a user programs to transmit a signal at a predetermined time.

In some embodiments, the transmitter 18 (alone or in connection with a communications system) is the only source for transmitting a signal to the vibration ringer 10. The wireless communications system 24 is then omitted from the system of FIG. 1. Alternatively, the signal can be sent from a wireless telecommunications system 24 without relaying the signal to the transmitter 18, and the transmitter 18 is optional.

Referring to FIG. 2, according to some embodiments, the vibration ringer 10 includes a housing 30 that encloses an actuator 34 and a vibration generator 40 powered by a power supply 42. The actuator 34 may also be powered by the power supply 42 or a further power supply. The housing 30 is surrounded by a cushioning layer 32. The vibration generator 40 is adapted to vibrate a pillow, such as the pillow 12 shown in FIG. 1. Vibrational motion may be obtained using a motor (not shown) operable to drive a weight (not shown) to move (e.g., to rotate or oscillate) in a suitable manner to create vibration. A transducer or any other suitable device and/or technique can also be used.

The actuator 34 for actuating the vibration generator 40 includes an antenna 36 and a processor 38. The antenna 36 receives a signal, which triggers the actuation of the vibration generator 40 by the actuator 34. The processor 38 processes signals from the antenna 36, stores information and/or controls the actuator 34 to provide other functions, such as blocking certain signals or specific telephone numbers.

As described above, the actuator 34 actuates the vibration generator 40 when the signal is received. However, in some embodiments, the actuator 34 actuates the vibration generator 40 after the time that the signal is received. That is, the processor 38 includes a clock or timer, and triggers the actuator 34 to actuate the vibration generator 40 at a predetermined time. For example, the signal received by the antenna 36 may include an actuation time such as a time for a wake-up alarm. The processor 38 stores the actuation time, and triggers the actuator 34 at the actuation time. Delaying actuation after the signal is received may be useful if the vibration ringer 10 is used as an alarm clock for waking a user from sleep. For example, the signal includes the actuation time and the processor 38 stores the actuation time and triggers the actuator 34 at the appropriate time.

As illustrated, the processor 38 is located in the vibration ringer 10. However, various configurations can be used. For example, the processor 38 can be a part of the transmitter 18 or another unit for programming the vibration ringer 10. Multiple processors can be used in various locations.

The housing 30 encloses and protects the vibration generator 40 and the actuator 34 and the power supply 42. The housing 30 can be made from a rigid or semi-rigid material to provide protection to the interior components (e.g., the actuator 34, the vibration generator 40 and the power supply 42). As described with respect to FIG. 1, as shown, the housing 30 is a disk shape suitable to provide vibrational motion to a pillow. Other suitable shapes may be used. For example, the housing 30 may be elongated to provide vibrational motion across a substantial area of the pillow in an elliptical or quadrilateral shape. Moreover, the housing can protect the vibration generator 40 and the actuator 34 from external forces and/or typical usage of the pillow.

The cushioning layer 32 is adapted to provide comfort to the user 16 (FIG. 1) during use to reduce the obtrusiveness of the vibration generator 10 within the pillow 12. The cushioning layer 32 is optional and can include a gel material, a foam material, or any other suitable material.

The power supply 42 is any suitable power supply such as a rechargeable or non-rechargeable battery for supplying power to the vibration generator 40 and/or the actuator 34. The power supply 42 can be integrated into either the actuator 34 or the vibration generator 40 or both. In certain embodiments, the vibration generator 40 and/or the actuator 34 operate at two or more power levels so that power from the power supply 42 can be conserved. For example, the vibration generator 40 operates at a relatively high level of power consumption when the vibration generator 40 is activated. When the vibration generator 40 is not activated, the actuator 34 and/or vibration generator 40 is set at a relatively low standby or “sleep mode” level of power.

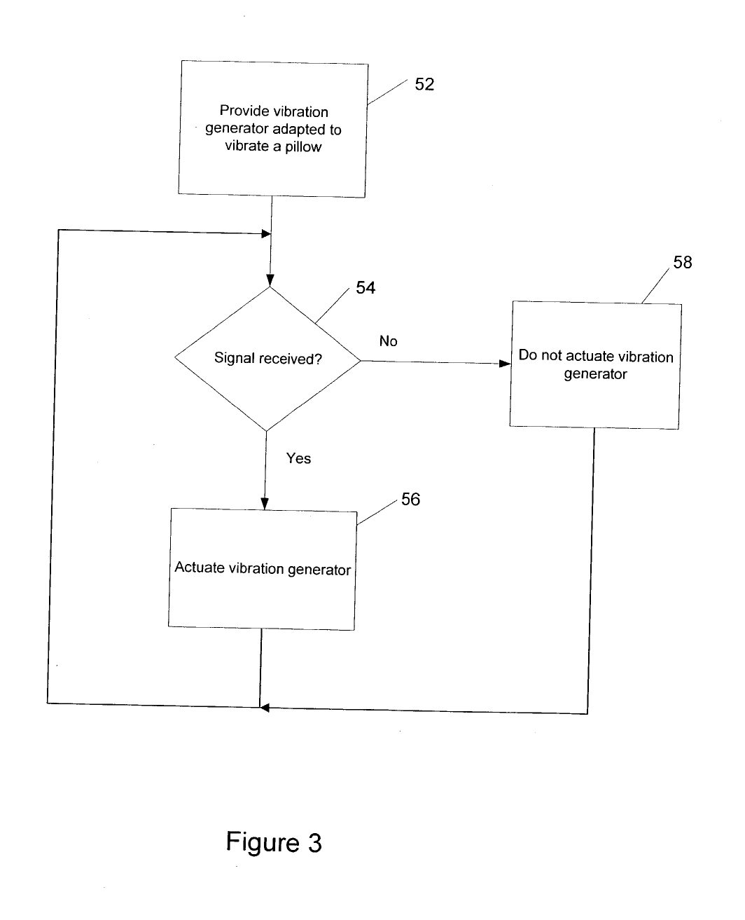

Referring to FIG. 3, operations according to embodiments of the present invention include providing a vibration generator such as the vibration generator 40 (FIG. 2) adapted to vibrate a pillow such as the pillow 12 (FIG. 1) (Block 52). For example, the processor 38 of FIG. 2 can determine if a signal has been received by periodically querying the antenna 36 to establish whether a signal has been received. If a signal is received (Block 54), then the vibration generator 40 is actuated (Block 56). If a signal is not received, the vibration generator 40 is not actuated (Block 58). The signal can be any suitable signal to actuate the vibration generator 40 as discussed above. As described with respect to FIG. 1, the vibration generator 40 is triggered by the actuator 34 using various techniques. For example, a telephone signal can be sent to the antenna 36 from the wireless communication system 24, which in turn activates the actuator 34. Alternatively, the telephone signal is sent to the transmitter 18, which in turn sends another signal to the antenna 36. Other suitable signals can be used, for example, signals from communication systems other than telephone systems can be used to actuate the vibration generator 40 at a predetermined time to provide an alarm.

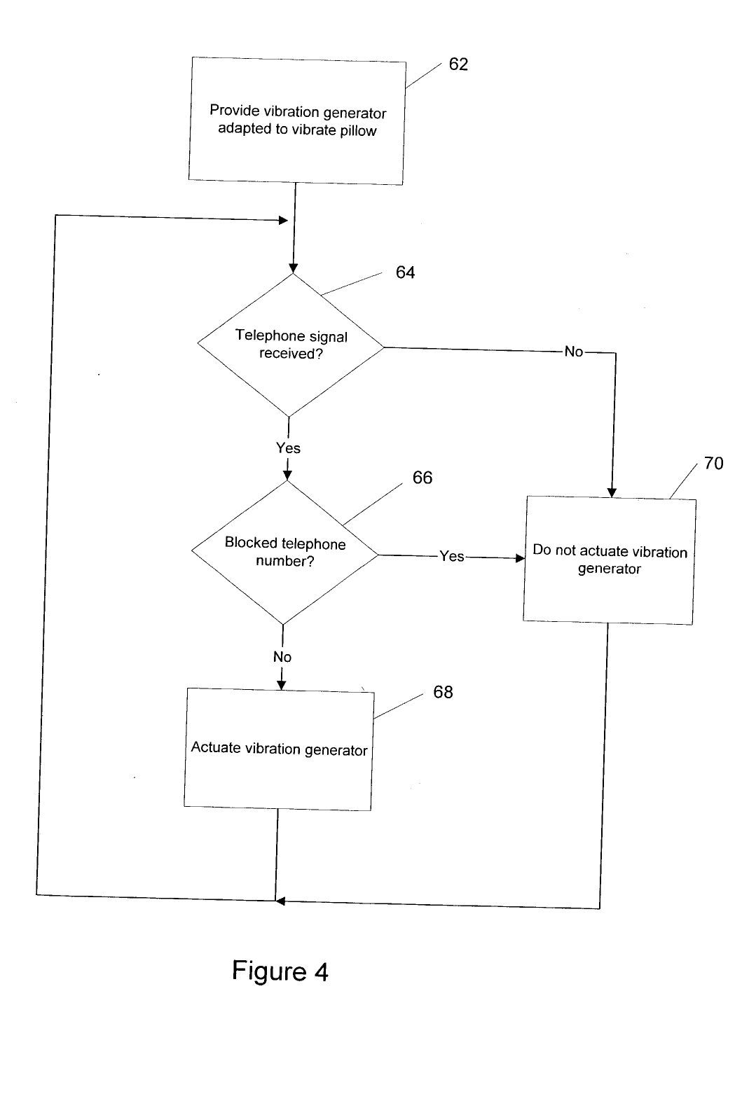

FIG. 4 illustrates operations according to certain embodiments of the present invention in which a particular telephone number is blocked. A vibration generator adapted to vibrate a pillow, such as vibration generator 40, is provided (Block 62). If a telephone signal is not received (Block 64), the vibration generator is not actuated (Block 70). If a telephone signal is received, the number of the incoming call is queried to determine if it is a blocked telephone number (Block 66). If the telephone number is a blocked number (Block 66), then the vibration generator is not actuated (Block 70). If the telephone number is not a blocked number, the vibration generator is actuated (Block 68).

In this configuration, the user can choose which calls to receive when the vibration ringer 10 is in use as shown in FIG. 1. The user can block calls by choosing which calls he wants to receive. For example, the user can program the processor 38 in FIG. 2 to block all calls except certain programmed telephone numbers.

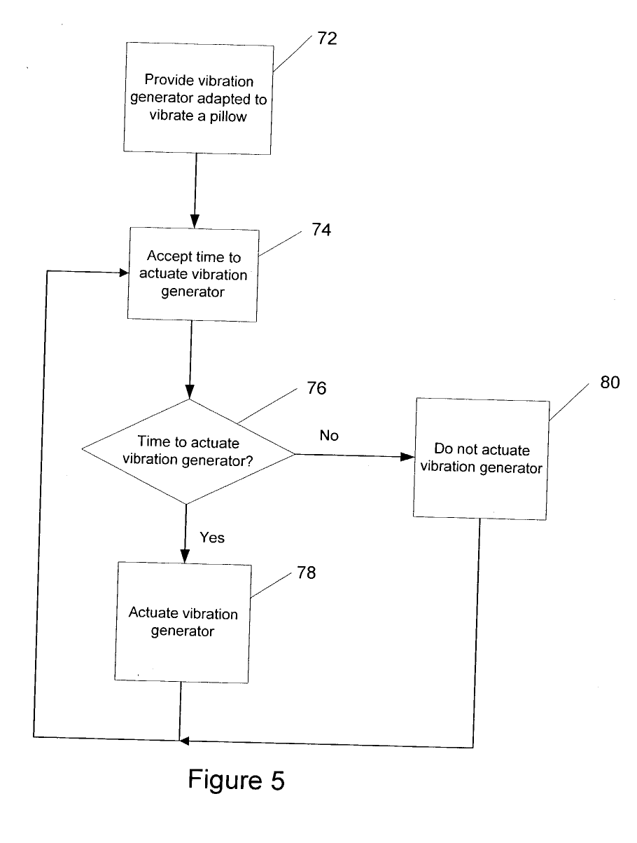

In some embodiments, the vibration generator 40 in the vibration ringer 10 is actuated at a predetermined time without requiring a signal from a communication system. For example, the vibration ringer 10 can be used as an alarm clock to awaken a user from sleep at a predetermined time. As shown in FIG. 5, a vibration generator (such as vibration generator 40 in FIG. 2) is adapted to vibrate a pillow (Block 72). A time to actuate the vibration generator is accepted (Block 74). For example, a processor accepts the time as an input from the user or a third party. The user or third party inputs a time using a keyboard, keypad, mouse, pointer, touch or light sensitive screen, or other suitable input devices. The time is input to the vibration ringer 10, e.g., and stored in processor 38. Alternatively, the time can be input to the transmitter 18 and transmitted to the antenna 36 in the vibration ringer 10. The actuation time can then be stored in the processor 38.

Referring again to FIG. 5, if it is not time to actuate the vibration generator (Block 76), then the vibration generator is not actuated (Block 80). However, if it is time to actuate the vibration generator (Block 76), then the vibration generator is actuated (Block 78). Actuating the vibration generator at the appropriate time can occur using various techniques. For example, referring to FIG. 2, the actuation time can be input to the transmitter 18, which can send a signal to the antenna 36 at the actuation time to actuate the vibration generator 40. Alternatively, if the actuation time is stored in the processor 38 as described above, the processor 38 can initiate the actuator 34 to actuate the vibration generator 40 at the actuation time.

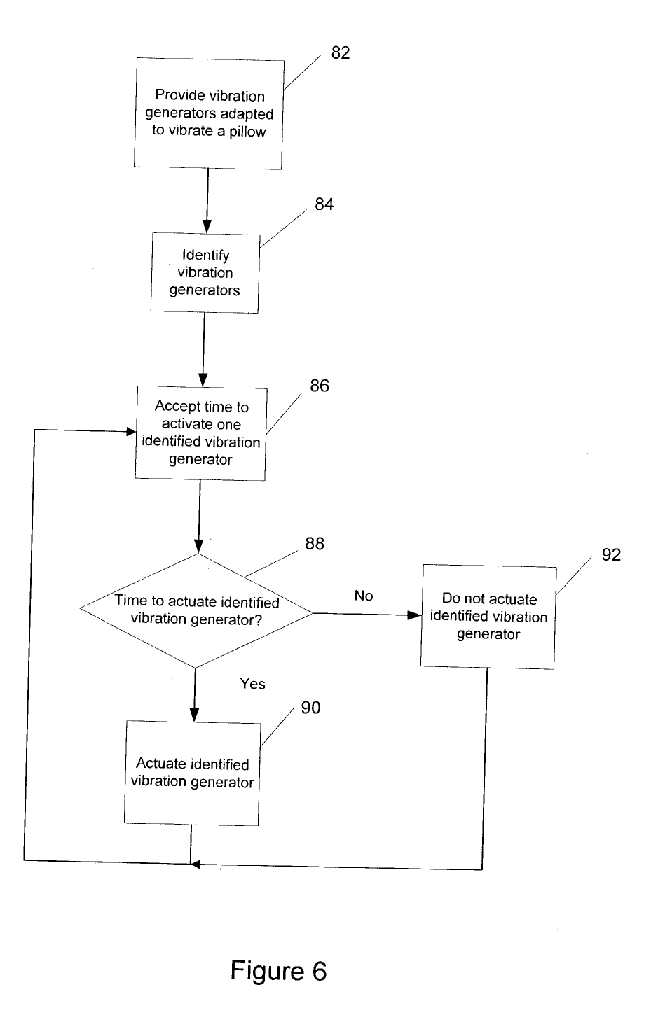

In other embodiments, a system is provided that can control the actuation times of a plurality of vibration generators. Such a system may be used, for example, to provide wake-up calls in a hotel or hospital setting. As shown in FIG. 6, vibration generators adapted to vibrate a pillow are provided (Block 82). Each vibration generator is identified (Block 84). For example, an identification code or number is assigned to each vibration generator. An actuation time to actuate one of the identified vibration generators is accepted (Block 86). If it is time to actuate the identified vibration generator (Block 88), the identified vibration generator is actuated (Block 90). If it is not time to actuate the identified vibration generator (Block 88), the identified vibration generator is not actuated (Block 92). The operations shown in FIG. 6 can be repeated to accept actuation times for a plurality of vibration generators. The vibration generators can be identified by location, for example, so that a user can remotely program an actuation time for a vibration ringer in a particular room location, such as in a hotel or hospital.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A vibration ringer for vibrating a pillow responsive to a signal, the vibration ringer comprising:
a vibration generator adapted for placement adjacent the pillow and adapted to vibrate the pillow providing a reduced sound vibration ring; and
an actuator adapted to actuate the vibration generator responsive to the signal.

2. The ringer of claim 1, wherein the signal is from a remote source.

3. The ringer of claim 1, wherein the vibration generator is adapted for placement in or under the pillow.

4. The ringer of claim 1, further comprising an antenna adapted to receive the signal from a wireless communication system.

5. The ringer of claim 1, further comprising a housing that encloses the vibration generator and the actuator.

6. The ringer of claim 5, further comprising a cushioning layer around the housing.

7. The ringer of claim 5, wherein the housing comprises a disk.

8. The ringer of claim 1, wherein the signal is a radio frequency paging signal.

9. The ringer of claim 1, further comprising a processor adapted to control the actuator.

10. The ringer of claim 9, wherein the processor is adapted to receive a time for actuation and the actuator is adapted to actuate the vibration ringer at the time for actuation.

11. A vibration ringer system for vibrating a pillow responsive to a signal, the vibration ringer comprising:
a pillow;
a vibration generator placed adjacent the pillow and adapted to vibrate the pillow providing a reduced sound vibration ring; and
an actuator adapted to actuate the vibration generator responsive to the signal.

12. The ringer of claim 11, wherein the vibration generator is removably affixed to the pillow.

13. The ringer of claim 11, wherein the vibration generator is embedded in the pillow.

14. The ringer of claim 11, wherein the vibration generator is in or under the pillow.

15. A vibration ringer system for vibrating a pillow, the vibration ringer system comprising:
a transmitter adapted to generate a signal;
a vibration ringer spatially removed from the transmitter, the vibration ringer comprising:
a vibration generator adapted for placement adjacent the pillow and adapted to vibrate the pillow providing a reduced sound vibration ring; and
an actuator adapted to actuate the vibration generator responsive to the signal from the transmitter.

16. The system of claim 15, wherein the signal from the transmitter is a radio frequency signal.

17. The system of claim 15, wherein the transmitter is in communication with a telecommunications system.

18. The system of claim 15, wherein the transmitter comprises a display adapted to display information regarding the signal.

19. The system of claim 18, wherein the information regarding the signal is a telephone number.

20. The system of claim 15, wherein the transmitter comprises a telephone jack connector.

21. A system of claim 15, wherein the transmitter further comprises a controller adapted to accept an actuation the for the vibration ringer and to transmit the signal to the actuator, wherein the actuator is further adapted to actuate the vibration generator at the actuation time.

22. The system of claim 19, wherein the signal comprises a representation of the actuation time.

23. The system of claim 19, wherein the controller is operative to transmit the signal at the actuation time.

24. The system of claim 19, further comprising a plurality of a vibration ringers, wherein the controller is further operative to associate the actuation time with at least one of the vibration ringers.

25. A method for providing a reduced sound vibration ring comprising:
vibrating a pillow responsive to a signal.

26. The method of claim 25, wherein the signal is a radio frequency signal.

27. The method of claim 25, wherein the signal is a remotely generated wireless signal.

28. The method of claim 25, wherein the signal is transmitted by a telecommunications system.

29. The method of claim 28, wherein the telecommunications system comprises a wireless communication system.

30. The method of claim 25, wherein the signal is a paging signal.

31. The method of claim 25, further comprising transmitting the signal from a transmitter adapted to receive signals from a telecommunications system.

32. The method of claim 25, further comprising displaying information regarding the signal.

33. The method of claim 32, wherein the information regarding the signal is a telephone number.

34. The method of claim 25, further comprising accepting a time of actuation, wherein the vibrating step occurs at the time of actuation.

35. The method of claim 34, further comprising transmitting the signal at the time of actuation.

36. The method of claim 34, further comprising transmitting the signal prior to the time of actuation, wherein the signal comprises a representation of the time of actuation.

37. A method for providing a reduced sound vibration ring comprising:
accepting an actuation time associated with one of a plurality of vibration ringers; and
vibrating the one of the plurality of vibration ringers at the actuation time.

38. The method of claim 37, further comprising providing a plurality of vibration ringers adapted to vibrate a pillow responsive to a signal.

39. The method of claim 37, wherein the signal is a radio frequency signal.
